(19) United States
(12) Patent Application Publication
(10) Pub. No.: US 2026/0247499 A1
(43) Pub. Date: Aug. 20, 2026

(54) MINERAL INSULATED CABLE, METHOD OF MANUFACTURING A MINERAL INSULATED CABLE, AND METHOD AND SYSTEM FOR HEATING A SUBSTANCE

(71) Applicant: SHELL USA, INC., Houston, TX (US)

(72) Inventors: Dhruv ARORA, Houston, TX (US); David Booth BURNS, Houston, TX (US)

(21) Appl. No.: 19/159,480

(22) PCT Filed: Feb. 27, 2024
(86) PCT No.: PCT/EP2024/054885

§ 371 Date: Aug. 25, 2025

Related U.S. Application Data
(60) Provisional application No. 63/489,447, filed on Mar. 10, 2023.

(51) Int. Cl. H05B 3/56; H01B 1/18; H01B 13/00; H05B 3/00; H05B 3/14

(52) U.S. Cl. CPC H05B 3/56; H01B 1/18; H01B 13/0006; H01B 13/0016; H05B 3/0014; H05B 3/141; H05B 2203/017; H05B 2203/019

(57) ABSTRACT

A mineral insulated cable includes an elongate core comprising a conducting ceramic-based material having a negative temperature coefficient. The elongate core is arranged on a central axis of the mineral insulated cable, and surrounded by an electrically insulating layer which comprises a mineral material. The conducting ceramic-based material is conductive relative to the electrically insulating layer. A metallic outer sheath concentrically envelopes around the electrically insulating layer. A current may be passed through the elongate core at high voltage, to generate up to 15 kW per meter of cable in heat.

### FIELD OF THE INVENTION

In one aspect the invention relates to a mineral insulated cable. In another aspect, the invention relates to a method of manufacturing a mineral insulated cable. In yet another aspect, the invention relates to a method of heating a substance with said mineral insulated cable and/or with a mineral insulated cable manufactured in accordance with said method. In still another aspect, the invention relates to a system for heating a substance with said mineral insulated cable and/or with a mineral insulated cable manufactured in accordance with said method.

### BACKGROUND TO THE INVENTION

U.S. Pat. No. 10,119,366 describes a mineral insulated heater cable, with a temperature limited heater as the heating member. “Temperature limited heater” generally refers to a heater that regulates heat output (for example, reduces heat output) above a specified temperature without the use of external controls such as temperature controllers, power regulators, rectifiers, or other devices.

The cable comprises a conductive core circumferentially surrounded by a thin concentric conductive layer, wherein another concentric layer of a ferromagnetic conductor separates the thin concentric conductive layer from the conductive core. The thin concentric conductive layer in turn is surrounded by a relatively thick concentric layer of electrical insulator comprising mineral insulation, such as MgO, and an outer metal jacket. The conductive core and the thin concentric conductive layer are made from a non-ferromagnetic material (e.g. copper or copper alloy). Below the Curie temperature and/or phase transformation temperature range of the ferromagnetic material, the magnetic properties of the ferromagnetic material confine the majority of the flow of electrical current to the thin concentric conductive layer. Thus, the thin concentric conductive layer provides the majority of the resistive heat output of the cable, below the Curie temperature and/or the phase transformation temperature range. The thin concentric conductive layer may have a cross-sectional area that is around 2 or 3 times less than the cross-sectional area of conductive core, so that the inner conductor provides a desired amount of heat output and a desired turndown ratio.

The temperature limited heater described above are operated by high frequency AC (alternating current) power or modulated DC (direct current) power, which is required to produce skin effect electricity flow in the ferromagnetic conductor. “Turndown ratio” for the temperature limited heater is the ratio of the highest resistance below the Curie temperature to the lowest resistance above the Curie temperature for a given AC or modulated DC current. However, this heater cable only works with AC or modulated DC, suffers from reactive power losses, and its overall behavior is frequency-dependent. In addition, a ferromagnetic core is required.

### SUMMARY OF THE INVENTION

In accordance with one aspect of the present invention, there is provided a mineral insulated cable, comprising:
an elongate core on a central axis of the mineral insulated cable;
an electrically insulating layer concentrically enveloping around the elongate core, comprising a mineral material;
a metallic outer sheath concentrically enveloping around the electrically insulating layer; wherein the elongate core comprises a conducting ceramic-based material having a negative temperature coefficient.

In accordance with a second aspect of the invention, there is provided a method of manufacturing a mineral insulated cable, comprising:
selecting a conducting ceramic based material, a metallic outer sheath, and an electrically insulating mineral material;
manufacturing an intermediate assembly comprising:
   providing an elongate core comprising the conducting ceramic based material;
   placing the elongate core on a central axis of the mineral insulated cable;
   arranging an electrically insulating layer comprising said mineral material concentrically enveloping around the elongate core; and
   arranging the metallic outer sheath concentrically enveloping around the electrically insulating layer;
      and
subjecting said intermediate assembly to diameter reduction comprising steps of mechanically working and heat treating.

The mineral insulated cable may be employed in a method of heating a substance, wherein:
passing an electrical current through the elongate core in a direction along the central axis;
bringing a substance to be heated in heat exchanging contact with the mineral insulated cable; and
transferring heat from the elongate core to the substance.

Finally, the mineral insulated cable may be comprised in a system for heating a substance, which system further comprises:
a vessel for retaining the substance to be heated, in which vessel the mineral insulated cable is arranged; and
a current supply in electrical connection with the elongate core of the mineral insulated cable, arranged to pass an electrical current through the elongate core in a direction along the central axis.

### BRIEF DESCRIPTION OF THE DRAWINGS

The drawing figures depict one or more implementations in accordance with the present teachings, by way of example only, not by way of limitation. In the figures, like reference numerals refer to the same or similar elements.

FIG. 1 shows a schematic cross-sectional view of a mineral insulated cable according to an embodiment of the invention;

FIG. 2 shows a schematic cross-sectional view of a mineral insulated cable according to another embodiment of the invention;

FIG. 3 shows a schematic cross-sectional view of a mineral insulated cable according to still another embodiment of the invention; and

FIG. 4 shows a schematic cross sectional view of a heater vessel comprising mineral insulated cables.

### DETAILED DESCRIPTION OF THE INVENTION

The person skilled in the art will readily understand that, while the detailed description of the invention will be illustrated making reference to one or more embodiments, each having specific combinations of features and measures, many of those features and measures can be equally or similarly applied independently in other embodiments or combinations.

The present disclosure provides a mineral insulated cable which includes an elongate core comprising a conducting ceramic-based material having a negative temperature coefficient (NTC). The elongate core is arranged on a central axis of the mineral insulated cable, and surrounded by an electrically insulating layer which comprises a mineral material. The conducting ceramic-based material is conductive relative to the electrically insulating layer. A metallic outer sheath concentrically envelopes around the electrically insulating layer.

The negative temperature coefficient causes a reduction of resistivity of the conducting ceramic-based material with increasing temperature. The result is a self-regulating mineral insulated heating cable. The heat that is dissipated per unit length in any section of the cable by the electrical current is proportional to local resistivity of the elongate core in that section of the cable. This means that hotspots in the cable are mitigated. The mitigation also works locally in sections of the cable, as the resistance, and thus also the dissipation rate of heat, will locally reduce with increasing (local) temperature in that section. Depending on whether the cable is powered by current control or voltage control, the total current through the heater cable may remain the same or increase slightly (due to a slight reduction of overall series resistance of the cable when the resistance in a local section drops), and thus heat continues to be dissipated in the remaining sections of the cable even if there is a local turn down in one or more sections.

Avoiding off global or local overheating of the cable (local hot spots) has many advantages, one of which is to avoid damage to the electrically insulating layer which surrounds the elongate core by ensuring the insulating properties are not compromised by overheating.

The resistance drop is independent from current frequency and advantageously it works with DC current so that reactive power loss can be avoided and all power can be used to heat up a substance.

The conducting ceramic-based material can be selected from a variety of materials and it does not need to be ferromagnetic. Suitably, the conducting ceramic-based material comprises an oxide such as magnesia, silica, alumina, beryllia, zirconia, or mixed oxides such as spinels. Preferably these ceramic materials may contain a minority quantity of alkaline oxides, such as (but not limited to) LiO₂; Na₂O, and K₂O. Amounts of from about 1 mol. % to about 10 mol. % are known to reduce the resistivity of pure metal oxides by several orders of magnitude.

By mixing in conducting materials (such as carbon, or metals such as copper, aluminum, iron, tin, nickel) the conductivity of ceramic materials can be increased to a desired level (to resistivity of typically less than 100 μΩ·m at 20° C.). Such materials typically may present a negative temperature coefficient of resistivity, meaning that the resistivity goes down with increasing temperature. The conducting materials may take the form of conducting particles dispersed in a matrix of otherwise ceramic material. These conducting particles may thus comprise carbon particles and/or metallic particles and/or compounds thereof.

The resistivity of the conducting ceramic-based material may be in a range of between 1 μΩ·m and 100 μΩ·m at 20° C. The resistivity may reduce by an order of magnitude at elevated temperature, depending on material selection. In some embodiments, the conducting ceramic-based material may display NTC thermistor behavior similar to certain semiconductor resistors. Such behavior is characterized by a relatively sharp temperature transition of resistivity. As used herein, the term ceramic-based material is used to refer to final material which comprises the ceramic material and the conducting particles dispersed therein. The term ceramic material is used to refer to the matrix material.

The conducting based material may be agglomerated to a rod. One way to agglomerate the material includes sintering. The rod, or a number of rods placed head-to-toe may, in one group of embodiments, constitute the elongate core and be in direct contact with the electrically insulating layer.

However, in another group of embodiments, the elongate core may further comprise a tube having a bore surrounded by a cylindrical wall, wherein the wall envelopes around the conducting ceramic-based based material. In this other group of embodiments, the conducting ceramic-based material is held within the bore of the tube. In such a case, the conducting ceramic-based material and the electrically insulating layer will be separated by the wall of the tube. Employing a tube packed with a semi-conducting filler has manufacturing advantages. An advantage of this group of embodiments is that the conducting ceramic-based material does not have to be agglomerated into a rod (although it still may be, if desired). Instead, the tube may be filled with a powder of the conducting ceramic-based material.

Another advantage of this group of embodiments is that the tube also provides an opportunity to adapt electrical behavior of the elongate core to specifications as needed for a certain heating application. Particularly, the tube itself may be an electrically resistive tube, whereby the cylindrical wall is made of a resistive material. The conducting ceramic-based material suitably extends through said bore in electrical contact with said wall along a substantial length of the resistive tube. By combining the electrically resistive tube with the conducting ceramic-based material, the electric current flowing through the elongate core in longitudinal direction, i.e. along the bore, will continuously partition its flow through the wall of the tube and through the conducting ceramic-based material packed in the bore (without wishing to be limited by theory, in accordance with Kirchoff's law) to minimize its overall resistance through the elongate core. The resulting combined local electrical conductance in any section along the length of the elongate core, is determined by the sum of the conductance of the wall of the tube and of the conducting ceramic-based material in that section. The temperature dependence of the resistivity will be a net result of the temperature dependence of the conducting ceramic-based material and the temperature dependence of the tube. As the conducting ceramic-based material is in electrical contact with the wall along a substantial length of the resistive tube, the current will continuously re-partition itself over the tube and the conducting ceramic-based material as it flows along the length of the elongate core.

The mineral material of the electrically insulating layer will always have a much higher resistivity than the conducting ceramic-based material in the elongate core, which will allow the mineral material to function as an electric insulator even at elevated temperatures.

In another group of embodiments, the conducting ceramic-based material of the elongate core may be provided as a concentric layer around an insulating core. The resistivity of the insulating core is generally lower, preferably at least 1000× lower, than the resistivity of the conducting ceramic-based material. The insulating core may be produced of the same material as the electrically insulating layer which concentrically envelopes around the elongate core. It is also a possibility, that the insulating core is made of the ceramic matrix material used in the conducting ceramic-based material. This group of embodiments may be combined with the group of embodiments described hereinabove, in which the elongate core further comprises a tube having a bore surrounded by a cylindrical wall. In such cases, the elongate core would comprise (from inside out) an insulating core, a concentric layer of conducting ceramic-based material, and the tube.

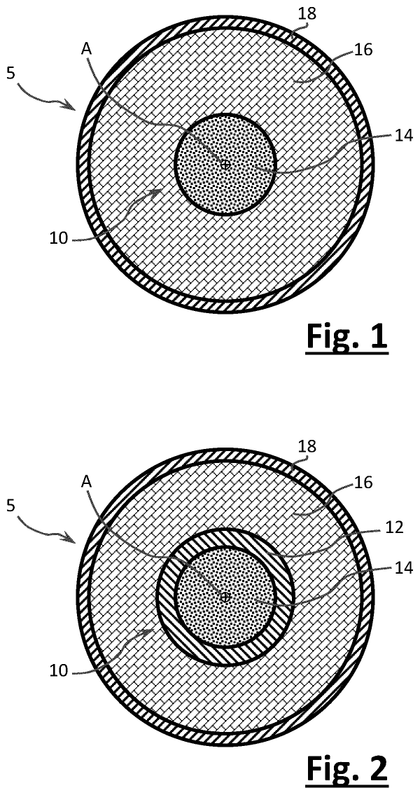

Turning now to FIG. 1, there is shown a cross sectional view of a first embodiment of a mineral insulated heater cable as proposed herein. At the heart there is an elongate core 10 on a central axis A. The elongate core 10 comprises a conducting ceramic-based material 14. The elongate core 10 is surrounded by an electrically insulating layer 16 concentrically enveloping the elongate core 10. A metallic outer sheath 18 concentrically envelops around the electrically insulating layer 16.

The metallic outer sheath 18 is preferably made of a chemically resistant and mechanically robust material, including at operating temperatures and in contact with the substances to be heated. Alloys that may be used in a desired operating temperature range of the cable include, but are not limited to, 304 stainless steel, 310 stainless steel, Incoloy® 800, and Inconel® 600 (Inco Alloys International, Huntington, W. Va., U.S.A.). The metallic outer sheath 18 may be coated with one or more protective coating layers. The thickness of the metallic outer sheath 18 may have to be sufficient to last for three to ten years in a hot and corrosive environment. The thickness may be in a range of between about 1 mm and about 3.5 mm. Larger or smaller thicknesses may be used, to meet specific application requirements.

The electrically insulating layer 16 may be made of a variety of materials, in particularly mineral materials. Suitable materials may include, but are not limited to, MgO, alumina, Zirconia, BeO, different chemical variations of Spinels, and combinations thereof. MgO may provide good thermal conductivity and electrical insulation properties. The desired electrical insulation properties include low leakage current and high dielectric strength. A low leakage current decreases the possibility of thermal breakdown and the high dielectric strength decreases the possibility of arcing across the insulator. Thermal breakdown can occur if the leakage current causes a progressive rise in the temperature of the insulator leading also to arcing across the insulator. The thickness of the electrically insulating layer 16 is predominantly a result of the maximum desired break down voltage between core 10 and the outer sheath 18 and of the insulating properties of the layer. However, for certain high-voltage applications (for example, potential difference of up to 10 kV), and a 85% compacted MgO as insulating layer 16, the thickness may need to be up to 25 mm. For most applications, the thickness range of the electrically insulating layer 16 will be from about 4 mm to 25 mm, preferably from about 9 mm to 25 mm.

The conducting ceramic-based material 14 comprises ceramic matrix, preferably an oxide matrix, such as an MgO matrix, having conducting particles dispersed in it. The resulting material typically possesses a negative temperature coefficient of resistivity. The resistivity of the conducting ceramic-based material may be in a range of between 1 μΩ·m and 100 μΩ·m at 20° C. The diameter of the elongate core 10 may in a range of between about 10 mm and about 40 mm.

FIG. 2 shows a second embodiment, which differs from the first embodiment in that the elongate core 10 comprises a tube 12 surrounding the conducting ceramic-based material 14. The tube 12 has a cylindrical wall made of a metal material.

This tube may be a resistive tube, made of a material having a resistivity of at least 0.05 μΩ·m at 20° C., preferably at least 0.1 μΩ·m, 0.3 μΩ·m or 0.5 μΩ·m at 20° C. Higher values may be preferred, typically ranging up to about 5 μΩ·m at 20° C. In certain embodiments, the material consists of resistive metal alloys, for example a nickel-chrome alloy. The wall thickness of the tube 12 in relation to the bore diameter and the resistivity of the selected metal material are selected such that the resistance of the tube 12 (as derived from Ohm's law) makes it electrically and structurally stable for a desired power dissipation per unit length, the length of the cable, and/or the maximum voltage allowed for the elongate core material. The wall thickness is typically in a range of from 0.5 mm to about 2.5 mm. However, preferred thickness is influenced by the resistivity of the material (for example, the resistivity at 20° C.) in combination with the desired heat output, length of cable, and available drive voltage, and thus larger or smaller thicknesses may be used depending on design parameters. The bore diameter of the resistive tube 12 may be selected in a range of for example between about 3.5 mm and about 38 mm, preferably between 5 mm and 38 mm, more preferably between 10 mm and 38 mm. The preferred diameter depends on the amount of desired resistance reduction in the elongate core and the type of semi-conducting material that is packed inside, and in some cases it may even be outside of the range described above.

The conducting ceramic-based material 14 packed in said bore is preferably in electrical contact with the wall along a substantial length of the tube 12. Due to its negative temperature coefficient, when the temperature of the elongate core in any section of the cable increases, the effective core resistance in that section will drop due to more of the current now being able to pass through the conducting ceramic-based 14 instead of the tube 12 wall. This will have a limiting effect on the amount of heat that can be generated.

The resistivity of tube 12 may be at least 0.05 μΩ·m at 20° C., which includes almost all metals except for the very best conductors. Examples include: tungsten and iron, or alloys such as brass, copper nickel and nickel chrome (“nichrome”), for example. By selecting materials with slightly higher resistivity, it is possible to achieve the desired heat output without making the wall thickness very thin. Preferably, a material is selected such that the resistivity is at least 0.3 μΩ·m at 20° C. This includes metals such as constantan. Most preferably, the resistivity is at least 0.5 μΩ·m at 20° C. This includes high resistive alloys such as nichrome and other alloys typically found in electrical resistive heating devices. The resistivity of the tube 12 is preferably less than 5 μΩ·m at 20° C., more preferably less than 2 μΩ·m at 20° C., and most preferably less than 1 μΩ·m at 20° C. Herewith the voltage drop per unit length of cable is kept at preferred levels.

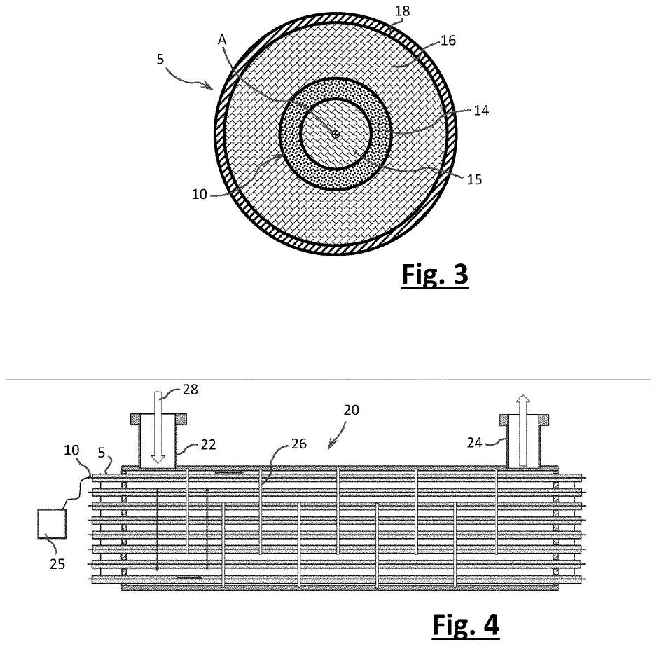

FIG. 3 shows a third embodiment, which differs from the first embodiment in that the elongate core 10 comprises an insulating core 15 surrounded by the conducting ceramic-based material 14. This embodiment may also be combined with the embodiment of FIG. 2. The insulating core allows for the localizing the conducting ceramic-based material 14 where it is the most effective, which is on the outside circumference (due to skin effect of conductivity).

In each of the above embodiments, the outer diameter of the entire mineral insulated cable may suitably be in a range of from about 25 to about 60 mm. In some embodiments, the mineral insulated cable may be capable of delivering more than 7 kW/m of cable length, for example up to 15 kW/m, and at a core temperature in a range of between 600° C. and 850° C., preferably between 700° C. and 850° C., and a temperature differential between core and sheath of between 250° C. and 400° C.

The mineral insulated cable described above may be manufactured in accordance with certain known methods of manufacture of conventional metal insulated cable, with the caveat being that the elongate core is not a monolith resistive wire but a conducting ceramic-based material based core, as described herein. Once the elongate core is available, the cable may be manufactured by placing elongate core on a central axis of the mineral insulated cable, arranging the electrically insulating layer concentrically enveloping around the elongate core, and arranging the metallic outer sheath concentrically enveloping around the electrically insulating layer. This intermediate assembly is then subjected to diameter reduction, comprising alternating steps of mechanically working and heat treating. This causes a compaction of the ceramic material in the insulating layer. The target compaction is defined by the desired break down voltage for the cable. As a rule of thumb, the target compaction is typically 85% or higher, where 100 % compaction is equal to the density of the crystal material. Usually, a diameter reduction of between 10% and 30% suffices to achieve the target compaction.

More details can be found in, for example, U.S. Pat. No. 10,119,366, which describes a manufacturing process in detail. Reference is also made to Chapter 16 of the Electric Cables Handbook/BICC Cables (3^{rd} edition edited by G. G. Moore, Blackwell Science Ltd., 1997). In a typical process of manufacture used to make (form) the mineral insulated cable, the metallic sheath of the cable starts as a strip of electrically conducting material (for example, stainless steel). The strip is formed (longitudinally rolled) into a partial cylindrical shape and electrical insulator blocks (for example, magnesium oxide blocks) are inserted into the partially cylindrical sheath. The inserted blocks may be partial cylinder blocks such as half-cylinder blocks. Following insertion of the blocks, the elongate core is placed in the partial cylinder and inside the half-cylinder blocks. Once the electrical insulator blocks and the elongate core are in place, the portion of the sheath containing the blocks and the elongate core may be formed into a complete cylinder around the blocks and the elongate core. The longitudinal edges of the strip may be welded to close the cylinder and form the mineral insulated cable with the elongate core and electrical insulator blocks inside the sheath. The process of inserting the blocks and closing the sheath cylinder may be repeated along a length of sheath, to form the intermediate assembly in a desired length.

After the intermediate assembly is formed, further steps may be taken to reduce gaps and/or porosity in the assembly and increase the breakdown voltage. The intermediate assembly may be moved through a progressive reduction system (cold working system) to reduce gaps in the assembly. One example of a progressive reduction system is a roller system. In the roller system, the intermediate assembly may progress through multiple horizontal and vertical rollers with the assembly alternating between horizontal and vertical rollers. The rollers may progressively reduce the size of the intermediate assembly into the final mineral insulated cable. Alternatively, the reduction may be achieved in a drawbench drawing processes wherein the intermediate assembly is pulled though a successive series of draw dies.

The mineral insulated cable assembly is preferably heat treated (annealed) between reduction steps. Without wishing to be bound by theory, heat treatment (annealing) of the assembly is believed to help to regain mechanical properties of the metal(s) used in the mineral insulated cable. Heat treatment (annealing) of the cable may be described as heat treatment that relieves stress and returns a material (for example, a metal alloy material) back to its natural state (for example, a state of the alloy material before any cold working or heat treating of the alloy material). For example, as austenitic stainless steels are cold worked, they may become stronger but more brittle until a state is reached where additional cold work may cause the material to break because of its brittleness. The strength of an annealed material, and the strength that may be achieved through cold working before failure may depend (vary) based on the material being treated.

In some embodiments, heat treatment allows for further reduction (cold working) of the mineral insulated cable. For example, the mineral insulated cable assembly may be heat treated to reduce stresses in metal in the assembly after cold working and improve the cold working (progressive reduction) properties of the metal.

Metal alloys (for example, stainless steel used as the sheath (or outer electrical conductor) in the mineral insulated cable may need to be quenched quickly after being heat treated. The metal alloys may be quenched quickly to solidify the alloy while the components are still in solution rather than allowing the components to form crystals, which may not contribute as needed to the mechanical properties of the metal alloy. During quenching, the metal sheath may be cooled down first, and then heat is more gradually transferred from the inside of the cable through the sheath. Thus, the metal sheath contracts and squeezes the electrical insulator (for example, the MgO), which further compacts the electrical insulator.

As the electrical insulator and the elongate core cool, they contract and may leave small voids and may relieve pressure from, for example, seams between electrical insulator blocks inside the mineral insulated cable assembly. The small voids or seams may contribute to increased pore volume and/or porosity in the electrical insulator, and may have an adverse effect on the dielectric breakdown voltage. For example, heat treatment may reduce the breakdown voltage by about 50% or more for typical heat treatments of metals used in the mineral insulated cable described herein. Such reductions in the breakdown voltage may produce shorts or other electrical breakdowns when the mineral insulated cable is used at medium to high voltages (for example, voltages of about 5 kV or higher). A final reduction (cold working) of the mineral insulated cable, after heat treatment, may be applied to restore breakdown voltages to acceptable values for long length heaters. The final reduction, however, should preferably not be as large a reduction as previous reductions, to avoid straining or over-straining the metal in the cable assembly beyond acceptable limits. Too much reduction in the final reduction may result in an additional heat treatment being needed to restore mechanical properties to the metals in the mineral insulated cable. Thus, the final reduction (cold working) step may reduce a cross-sectional area of the mineral insulated cable enough to compress the electrical insulator and reduce or essentially eliminate voids in the electrical insulator (for example, decrease pore volume and/or porosity) to restore breakdown voltage properties of the electrical insulator to desirable levels.

In one group of embodiments, the elongate core essential consists of the conducting ceramic based material which has been agglomerated into a rod. This may be achieved by mixing a ceramic powder, together with conducting particles, with a liquid binder to form an uncured base material. The uncured based material may then be formed into an uncured rod, by extruding or other suitable technique. The uncured rod may then be heated to agglomerate the ceramic powder and the conducting particles whereby the conducting particles are dispersed in a matrix of ceramic material. The heating may result in sintering of particulates within the rod.

In another group of embodiments, whereby the conducting ceramic-based material is arranged within the bore of a tube, manufacture of the elongate core may include packing a bore of said tube with the conducting ceramic-based material.

There are multiple options to accomplish the packing of the conducting ceramic-based material in the elongate core. Three examples are briefly discussed. The first is to provide a tube in preferentially vertical arrangement and fill the bore of the tube from the top with a powder of the conducting ceramic-based material. Vibration and/or ramming may be applied, to more effectively pack the powder within the bore. The elongate core thus provided has a predetermined determined length.

The second example of manufacturing the elongate core is similar as above wherein, instead of powder, macroscopic consolidated blocks (e.g. cylindrical blocks) of the conducting ceramic-based material are inserted in the bore of the tube. In this example, the tube may be oriented horizontally. Preferably, the macroscopic consolidated blocks fit snugly inside the bore. Small gaps are acceptable as these may disappear in the subsequent reduction steps. The elongate core thus provided has a predetermined determined length.

The third example is a semi-continuous process wherein the tube is provided in the form of a formable strip (suitably a metal strip or a workable polymer), and subsequently formed around macroscopic consolidated blocks (e.g. cylindrical blocks) of the conducting ceramic-based material much like how the metallic sheath is formed around the mineral insulating material as described above. The tube may optionally be sealed together by the meeting long edges, such as by welding, but in some embodiments sealing is not needed. The resulting elongate core made by this example may be indeterminate in length.

The macroscopic consolidation of the conducting ceramic-based material in the second and third examples may be achieved by sintering.

The mineral insulated cable described herein and/or manufactured as described herein, can be used to heat a substance. FIG. 4 schematically illustrates one example of system for heating a substance, which employs a heat exchanger generically modelled after a tube and shell heat exchanger. The system comprises a vessel 20 for retaining the substance to be heated. The vessel 20 may suitably comprise an inlet 22 and an outlet 24, for passing the substance 28 to and from the vessel 20 through, in analog, would typically be referred to as the shell side of the heat exchanger. The mineral insulated cable 5 may be arranged within the vessel in lieu of heating tube or it may be guided through the vessel inside a conduit. The skilled person will understand that many variations and possibilities exist.

In the embodiment as shown, a number of parallel arranged cables 5 is depicted, each of which in a single pass arrangement. The skilled person will understand that many variations are possible, including applying 180° U bends to create multiple passes with one cable. A number of baffles 26 may be provided to better distribute substance across all cables 5. A current supply 25 is in electrical connection with the elongate core 10 of the mineral insulated cable 5. Only one connection pole is schematically shown in FIG. 2. The skilled person will recognize there are many variations possible for the return connection. In use, the substance 28 to be heated will be in heat exchanging contact with the mineral insulated cable 5, while an electrical current passes through the elongate core 10 which resistively heats the cable 5. Heat is then transferred from the cable 5 to the substance 28. Local overheating of the cable 5 (in a hotspot) is avoided by the provision of self-regulating local resistance reduction anywhere within the cable 5 as described herein. Heat exchanging contact may be achieved through direct physical contact or through indirect contact via one or more other intermediate materials.

A typical vessel 20 as shown in FIG. 4 may be cylindrical in shape, and may have a diameter of typically between 2 m and 5 m and a length of typically between 10 and 30 m. However, depending on requirements, the vessel may be shaped differently and/or sized outside of these typical ranges. In some embodiments there may be several km, in some instances up to 10 km, of total cable length provided within the vessel in order to achieve high heating duty. Heating duty may exceed 10 MW.

In a preferred embodiment, the substance is heated using electricity that is generated by renewable generation, such as wind or solar, and heat may be extracted from the substance in case of temporary turn down of the renewable generation. The substance to be heated may for example be a molten salt. Molten salt is a commonly proposed solution to energy storage. Typical choices in include eutectic mixtures to lower their melting point, but the present invention is not limited by any particular selection of salt or mixture.

The above described heating vessel is an example wherein the mineral insulated cable is used for process heating. The cable may be immersed in and/or fully surrounded by a flowing substance to be heated. The mineral insulated cable may also be applied to heat pipes and vessels and the like by electric trace heating, whereby the mineral insulated cable runs in physical contact on the outside of a pipe or vessel (or the like). The mineral insulated cable may be packed together with the pipe or vessel underneath a layer of thermal insulation material.

The person skilled in the art will understand that the present invention can be carried out in many various ways without departing from the scope of the appended claims.

1. A mineral insulated cable, comprising:
an elongate core on a central axis of the mineral insulated cable;
an electrically insulating layer concentrically enveloping around the elongate core, comprising a mineral material;
a metallic outer sheath concentrically enveloping around the electrically insulating layer;
wherein the elongate core comprises a conducting ceramic-based material having a negative temperature coefficient.

2. The mineral insulated cable of claim 1, wherein conducting ceramic-based material is agglomerated to a rod.

3. The mineral insulated cable of claim 1, wherein said elongate core further comprises a tube having a bore surrounded by a cylindrical wall, wherein the wall envelopes around the conducting ceramic-based material whereby the conducting ceramic-based material is held within the bore of the tube.

4. The mineral insulated cable of claim 3, further comprising wherein the tube is a resistive tube whereby the cylindrical wall is made of a resistive material, whereby the conducting ceramic-based material extends through said bore in electrical contact with said wall along a substantial length of the resistive tube.

5. The mineral insulated cable of claim 4, wherein said resistive material has a resistivity of at least 0.05 μΩ·m at 20° C.

6. The mineral insulated cable of claim 5, wherein the resistivity is less than 5 μΩ·m at 20° C.

7. The mineral insulated cable of claim 3, wherein said cylindrical wall is made of a metal.

8. The mineral insulated cable of claim 1, wherein the conducting ceramic-based material of the elongate core is provided as a concentric layer around an insulating core.

9. The mineral insulated cable of claim 1, wherein the conducting ceramic-based material comprises conducting particles dispersed in a matrix of ceramic material.

10. The mineral insulated cable of claim 9, wherein the conducting particles comprise carbon particles and/or metallic particles.

11. A method of manufacturing a mineral insulated cable, comprising:
selecting a conducting ceramic-based material, a metallic outer sheath, and an electrically insulating mineral material;
manufacturing an intermediate assembly comprising:
providing an elongate core comprising the conducting ceramic-based material;
placing the elongate core on a central axis of the mineral insulated cable;
arranging an electrically insulating layer comprising said mineral material concentrically enveloping around the elongate core; and
arranging the metallic outer sheath concentrically enveloping around the electrically insulating layer;
and
subjecting said intermediate assembly to diameter reduction comprising steps of mechanically working and heat treating.

12. The method of claim 11, wherein providing said elongate core comprises:
mixing a ceramic powder and conducting particles with a liquid binder to form an uncured base material;
extruding said uncured based material into an uncured rod;
heating said uncured rod to agglomerate the ceramic powder and the conducting particles whereby the conducting particles are dispersed in a matrix of ceramic material.

13. The method of claim 11, wherein providing said elongate core comprises packing a bore of a tube with the conducting ceramic-based material.

14. A method of heating a substance, comprising:
providing a mineral insulated cable according to any one of claims 1 to 10 and/or manufactured according to claim 11;
passing an electrical current through the elongate core in a direction along the central axis;
bringing a substance to be heated in heat exchanging contact with the mineral insulated cable; and
transferring heat from the elongate core to the substance.

15. A system for heating a substance, comprising:
a vessel for retaining a substance to be heated;
a mineral insulated cable according to claim 1, arranged within the vessel;
a current supply in electrical connection with the elongate core of the mineral insulated cable, arranged to pass an electrical current through the elongate core in a direction along the central axis.
